(19) United States
(12) Patent Application Publication
(10) Pub. No.: US 2004/0069600 A1
(43) Pub. Date: Apr. 15, 2004

(54) Keyboard and apparatus comprising the same

(76) Inventor: Qingyun Xie, Hebei (CN)

Correspondence Address: STERNE, KESSLER, GOLDSTEIN & FOX PLLC, 1100 NEW YORK AVENUE, N.W., WASHINGTON, DC, 20005, US

(21) Appl. No.: 10/463,842

(22) Filed: Jun. 18, 2003

(30) Foreign Application Priority Data
Jun. 18, 2002 (CN) 02240593.3
May 22, 2003 (WO) PCT/CN03/00377

(51) Int. Cl. H01H 9/26

(52) U.S. Cl. 200/5 R

(57) ABSTRACT

The present application discloses a keyboard and an apparatus comprising a keyboard. In the keyboard, with the user's habits and ergonomic principles taken into account, the widths of the key rows and/or key columns are made different, so that the keyboard may be miniaturized sufficiently while ensuring its normal operation. To operate the keyboard accurately, separating ribs may be arranged between the keys for preventing the keys from being mis-switched on.

### CROSS-REFERENCE TO RELEVANT APPLICATIONS

The present application is based on and claims the priority of CN Application No.02240593.3 filed on Jun. 18, 2002 and titled as “A Portable Keyboard”, and PCT Application NO. PCT/CN03/00377 filed on May 22, 2003 and titled as “Keyboard and Apparatus Comprising the Same”, both of which are incorporated herein as references.

### TECHNICAL FIELD

The present invention relates to a keyboard, especially a keyboard used in computer, PDA (Personal Digital Assistant), mobile phone and other portable information equipment, and apparatus comprising a keyboard.

### BACKGROUND ART

Keyboard is the primary input device of information equipment such as computer, PDA, mobile phone and etc. The keyboard used in computer generally comprises a plurality of keys, a matrix of single-contact switches, each of which becomes on when the corresponding key is pressed, keyboard controller circuits and a keyboard body carrying aforementioned components and circuits, and is connected to a computer via a keyboard adapter. On the key panel and/or the keys may be printed some indications, e.g. key codes such as “A”, “B”, “C”, . . . , “Home”, “Ctrl” and so on and so forth. Indicators for indicating the status of the keyboard, e.g., indicator light such as LED (Light Emitting Diode), may also be provided on the key panel. The top of each key is generally in a concave form and small protrusions are formed on the top of particular keys, such as “F” key and “J” key, so that the user is easy to locate the keys by touch sense. When a user is about to input information, or during any pause in inputting operation, the eight fingers other than the two thumbs rest on eight keys including said keys provided with small protrusions (hereinafter said eight keys are referred to as “aligning keys”). In a conventional QWERTY keyboard, the aligning keys comprise the following keys: ‘a’, ‘s’, ‘d’, ‘f’, ‘j’, ‘k’, ‘l’, ‘;’.

Now the operating principle of a computer keyboard is described briefly.

The keyboard controller comprises substantially a scanning control circuit, an encoding circuit and an interface. The scanning control circuit functions for scanning said single-contact switch matrix. When a user presses a particular key, the monitoring program scans the switch matrix, removes jitters and performs encoding, and then the code thus obtained is transmitted to the computer processor.

In some simpler computer keyboards, there is only a switch matrix. A processor in the computer executes a special keyboard scanning program that analyzes the position(s) of pressed key(s) and converts the position(s) into corresponding code(s).

The contents input by a keyboard is determined by the switch matrix and key code definitions. In a computer, what a key stroke will be interpreted as is determined by the switch matrix and a corresponding key code table.

The keyboards used in portable information apparatus such as PDA, mobile phone and etc. operates with similar principle, which is omitted here.

For meeting the needs of various applications, such as for applying to desk top PC, notebook PC, PDA or mobile phone, for meeting the ergonomic requirements, there are various keyboard layouts.

The layout of a keyboard consists of the following aspects:

(1) The number of the switches of said switch matrix, that is, the number of the keys. For example, a full-size keyboard of a desktop PC generally has the most number of keys, such as 108 keys. As to the keyboard used in notebook PC, generally the keypad is omitted so that the total size may be reduced. The keyboard used in banks for inputting passwords generally consists of 12 keys. In mobile phone, the keyboard is formed by adding some function keys to number keys. Different number of keys will result in different encoder and different key code table, both of which may be realized by means of conventional techniques.

(2) The assignment of key codes (sensu stricto layout). For example, computer keyboard is derived from the keyboard of conventional alphabetical typewriter and includes a standard set of keys of printable characters, the layout of which is generally the QWERTY layout, or the AZERTY layout of European typewriter. A keyboard also includes some non-character controlling keys, such as the keys of ‘Ctrl’, ‘Alt’ and ‘Shift’ and etc. On one side, generally in the right-bottom portion of the keyboard, there is a keypad. In a notebook PC, in which the size of keyboard is reduced as mentioned above, the keypad is generally provided in the main region (the left-bottom region of a conventional keyboard, or the region including the letter keys) of the keyboard, that is, some keys in the main region of the keyboard may be switched into a state of functioning as a keypad. Whether in a computer or in a PDA or mobile phone, the layout of the keyboard may be switched into various layouts, such as Chinese stroke layout or Japanese kana layout in computer keyboard, and number key layout, letter key layout, symbol key layout or stroke key layout in mobile phone, and so on and so forth. The switching of the layouts is generally realized through software, such as afore-mentioned key code table, and belongs to conventional techniques. A person skilled in the art knows that when replanting a keyboard from one application to another application, for example, replanting a computer keypad into mobile phone, the structure of the encoder may be, or has to be modified. Such modification also belongs to conventional techniques.

(3) The mechanical construction of the keyboard, including the shape and the size. In recent years, various keyboards meeting ergonomic requirements have been developed. For example, for making the user's arms comfortable, a kind of keyboard is designed as having a left hand sub-keyboard and a right hand sub-keyboard, which make a certain angle. Some proposed layouts aim to reduce the size. For example, in the notebook PC keyboard, generally, the width of the upper-most key row (function keys such as ‘F1’, ‘F2’, and so on) and/or the space between that row and its adjacent key row are decreased; or even, the sizes of all the keys and all the spaces between rows and columns may be reduced. In PDA and mobile phone, the row width and row space are further decreased. For miniaturizing the apparatus adopting keyboard, the keyboard may further be designed as foldable.

With the development of portable apparatus such as PDA, mobile phone and etc., and with the emerging of dressing (or wearable) computer, there are more and more needs for miniaturized, portable keyboards that enabling quick input. As a result, many kinds of miniaturized keyboards or portable keyboards have been proposed. As mentioned above, once the number of keys (i.e., the number of the single-contact switches in the switch matrix), the key code layout, the shape and the size of a keyboard have been determined, the keyboard is determined since the circuit construction and the implementation of the software belong to conventional techniques. Therefore, modifications or developments of keyboard generally focus on the afore-discussed three aspects.

A typical miniaturized keyboard is that used in PDA. PDA keyboard comprises keys of all the numbers and letters, and some symbol keys and function control keys. The number of keys is great. Consequently, for reducing the volume, both the spaces between and the sizes of the keys are reduced, resulting in that, on one hand, the keys tend to be mis-switched on; on the other hand, it is impossible to operate the keys in a manner of the standard keyboard, and a user can only touch the keys finger by finger with poor efficiency. As for note book PC, considering the operating habit of user and operating speed, full-size or near full-size keyboard is still adopted. In mobile phone, on one hand, the keyboard occupies a large area that obstructs further enlarging of the display screen; on the other hand, when inputting letters and/or symbols by re-defining (switching) the codes of the keys, which are initially defined as number keys, the operation is very complex and time-consuming.

To solve one or all of the above problems, a plurality of solutions has been proposed. For example, for avoiding mis-switching-on of the keys and for purpose of protecting privacy, the applicant of Chinese Patent Publication CN2415378Y proposed a keyboard used in banks for inputting passwords, in which keyboard, a raised aligning frame is provided around each key. In the patent application PCT/CN00/00490(Publication No.WO02/42988A1) of the present applicant, a portable keyboard is disclosed as comprising a set of movable keys, which are to be worn on fingers, and a set of beaten keys, which are mounted on the body of the keyboard, the combinations between the movable keys and the beaten keys are mapped into a switch matrix similar to that of a conventional keyboard, wherein concave and/or convex separating regions are provided between the beaten keys.

As another example, for guiding beginners to operate a keyboard with correct fingering, Chinese Patent No.99237069.8(CN2388667Y) proposed to arrange guiding means comprised of separating bars between the respective moving ranges of respective fingers.

In Chinese Patent No.01226871.2(CN2484589Y), it is proposed to arrange the number keys between the left portion and the right portion of the letter keys region, so that the keyboard could well meet the ergonomic requirements. In the patent, the keyboard is further designed as foldable for convenience of carry.

Still another example. In Chinese Patent Application Publication No.CN1182907A, there was disclosed a keyboard of portable electronic apparatus, wherein the key buttons are designed as point like shape so that mis-switching-on thereof by fingers could be avoided.

However, from above it could be concluded that it is still desirable to have a keyboard that is further miniaturized and more portable while ensuring that the user may operate it comfortably and quickly.

### SUMMARY OF THE INVENTION

Therefore, the object of the invention is to provide a keyboard that is farther miniaturized.

Above object is realized by a keyboard comprising a plurality of keys and keyboard body supporting said keys, wherein, the width of the row that the aligning keys belong to (hereinafter referred to as aligning key row) is greater than the width of any other key row. Thus, compared to conventional keyboard, the keyboard size is reduced through reducing the row width of almost all the key rows (and thus the size of almost all the keys). In the mean time, since the row and the columns that the aligning keys belong to remain conventional widths, and thus the aligning keys remain conventional sizes, the keyboard could meet the user's habit all the same.

Further, the widths of columns that the aligning keys belong to (hereinafter referred to as “aligning key columns”) are greater than the width of any other key columns.

To avoid the mis-switching-on of the keys of the miniaturized keyboard, it is preferable to arrange separating ribs between key rows and/or key columns. On one hand, the separating ribs may guide the fingers. On the other hand, when one key is being pressed, the separating ribs prevent its adjacent keys from being mis-touched and thus mis-switched on due to the small size and high density of the keys. To make the user easy to locate the keys of the miniaturized keyboard, it is preferable to design the keyboard so that the distribution, in the direction of the key columns, of the heights of the top surfaces of the keys and the heights of the separating ribs is in a form of a wave. For a keyboard having 6-7 key rows, the aligning key row may be lower than its adjacent key rows, the intermediate key rows respectively of the two sets of key rows on the two sides of the aligning key row are located respectively at two peaks. Thus, the distribution of heights constitutes a wave having two peaks. The keyboard having such a distribution will be thinner than a keyboard in which said distribution is in form of a wave having only one peak. With such distribution, it is easier for user to locate the keys by finger because, on one hand, the different key rows have different heights; on the other hand, the wave-like distribution results in that the actual area of the key board is increased.

The separating ribs around a key may have different heights that transit smoothly. Along any key column, the heights of the top surfaces of keys when the keys are pressed down and the corresponding switches become on (hereinafter referred to as on-height), the heights of the top surfaces of keys in free state (hereinafter referred to as free height), and the heights of the separating ribs meet the following relation: the free height of any key in the valley of the wave is smaller than the height of either of its adjacent separating ribs; the on-height of any key on the peak of the wave is larger than the height of either of its adjacent separating ribs; for the other keys of different heights and the other separating ribs of different heights, the height of any separating rib is smaller than the on-height of the higher of its two adjacent keys and larger than the on-height of the lower of said two adjacent keys, and is preferable selected within the range of from the free height of the lower key plus one half of the travel length of that key to that free height minus one half of that travel length.

To make a beginner easy to locate keys, key code indication may be necessary. Considering that the widths of key rows and/or of key columns are reduced, the key code indications, which conventionally are printed on the top surfaces of the keys, may be extended onto the key panel (the portion, of the top surface of the keyboard, where there is no key) and/or separating ribs around corresponding keys, even onto the top surface(s) of adjacent larger key(s).

When operating a miniaturized keyboard, the two hands will be closer, which does not meet ergonomic requirements. Therefore, it is preferable to separate the left hand keys region and the right hand keys region by a distance, and to arrange necessary keys that in conventional keyboards are arranged around the letter keys or within the keypad between said left hand keys region and right hand keys region.

To meet the user's habit and psychology, reduce the labor of fingers and prevent the aligning keys from being mis-switched on when the fingers return to the aligning keys, the keys of the keyboard may be designed as having different pressure thresholds (the smallest pressure necessary to press a key down and thus switch it on). That is, the pressure threshold of the aligning keys and the space key (i.e., those keys having larger sizes, including the key(s) corresponding to the thumbs and the aligning keys) is larger than that of most of or all the keys having smaller sizes (i.e., the keys other than the aligning keys and the key(s) corresponding to the thumbs), The keyboard may be formed as having a left keyboard portion and a right keyboard portion. The two portions may be detachably articulated. Thus, the keyboard may be detached into two sub-keyboards, or may be folded to be carried more easily. In particular, the keyboard may be folded with the left and right keyboard portions face to face (the key panels of the two portions faces each other) or back to back (the back surface of the keyboard body faces each other). When folded with the two portions back to back, the keyboard may be used as a mono-hand keyboard (a keyboard to be operated by one hand), and a change-over switch may be provided for switching the keyboard between a mono-hand mode and a both-hand mode (normal mode).

For the miniaturized keyboard of the invention, generally, the keyboard processor is bonded on a printed circuit board on which LED(s) and circuit elements are mounted. To reduce the cost of short run production, a simple way is to arrange a keyboard processor circuit board of a prior art membrane keyboard beneath a printed circuit board merely comprising a switch matrix and in a region corresponding to the central portion of said printed circuit board, to connect the corresponding leads of the two circuit boards by means of connecting devices such as plug and socket or electrically conductive rubber strips, thereby complete a keyboard circuit board.

According to a variant of the invention, in the direction of key row, left hand keys and right hand keys are arranged alternating, and the widths of the key columns among the right hand keys are greater than the widths of the key columns among the left hand keys, or in reverse. The variant is suitable to be operated by only one hand in a manner of operating normal keyboard.

Another object of the invention is to provide a portable information apparatus and a keyboard thereof, which keyboard is more economical and more efficient in terms of space utilization.

Accordingly, according to a variant of the invention, the width of the aligning key row is greater than the widths of key columns. The main region of the keyboard may comprises at least four key rows and three key columns, and row separating ribs and column separating ribs are provided respectively between the key rows and between the key columns, wherein the two key rows adjacent to the aligning key row are higher than said aligning key row and the fourth key row, the on-height of any key in the higher key rows is higher than its two adjacent row separating ribs, and the free height of any key in the lower key rows is lower than its two adjacent row separating ribs; the intermediate key column on the peak is higher than the two side key columns on its two sides, and the on-height of any key in the intermediate key column is higher than its adjacent column separating ribs, the on-height of any key in the two side key columns is higher than the outermost column separating ribs but lower than the column separating ribs between the side key columns and the intermediate key columns.

The invention also provides a portable information apparatus, comprising a keyboard of above variant, which is disposed on a first side surface of the apparatus and is to be operated by the thumb of the hand grasping the apparatus, and a plurality function keys, which are arranged on a second side surface of the apparatus and are to be operated by the other four fingers of the grasping hand. In the inventive apparatus, the keyboard and the function keys may be operated either independently or in combination. When operated in combination, the keyboard and the function keys may be defined so that each combination of the keyboard with one of the plurality of function keys corresponds to a different set of key codes.

In above solutions, as in prior art keyboard, the key rows and/or key columns may be in alignment, or, part of or all the key rows and/or key columns may be arranged in a staggered manner. In addition, the specific definition of key codes may be modified as circumstances demand and such modification belongs to common techniques. For example, the shift codes of the number keys may be defined as mathematical operators; or at least one key may be defined for switching by user the default codes of multiple-code keys; and so on.

### BRIEF DESCRIPTION OF THE DRAWINGS

From the following detailed description of the preferred embodiments with reference to the accompanying drawings, the features and advantages of the invention will be understood completely. In the drawings:

FIG. 1 is a plan view of a keyboard according to a first embodiment of the invention;

FIG. 2A is a section view along A-A line in FIG. 1, showing the keyboard with all the keys in a free state;

FIG. 2B is a section view along A-A line in FIG. 1, showing the keyboard with all the keys in a switched-on state;

FIG. 3 is a perspective view of a keyboard of a second embodiment of the invention;

FIG. 4 is a plan view of a keyboard according to a third embodiment of the invention;

FIG. 5A is a section view along E-E line in FIG. 4, showing the keyboard with all the keys in a free state;

FIG. 5B is a section view along E-E line in FIG. 4, showing the keyboard with all the keys in a switched-on state;

FIG. 6 is a perspective view of an apparatus comprising a keyboard of a fourth embodiment of the invention;

FIG. 7 is a plan view of a keyboard of a fourth embodiment of the invention;

FIG. 8 is a section view of the keyboard of FIG. 4 along F-F line;

FIG. 9A is a section view along D-D line in FIG. 7, showing the keyboard with all the keys in a free state;

FIG. 9B is a section view along D-D line in FIG. 7, showing the keyboard with all the keys in a switched-on state;

FIG. 10 is a schematic view illustrating that the keys tend to be mis-switched on when no separating ribs are provided;

FIG. 11 is a schematic view illustrating that the keys are prevented from being mis-switched on when separating ribs are provided;

### DETAILED DESCRIPTION OF THE PREFERRED EMBODIMENTS

The preferred embodiments of the invention will now be explained in details with reference to the accompanying drawings.

First, some concepts used in the present description will be explained.

A key row refers to a transversal line (in a direction of from the left to the right or in reverse) of keys, e.g., as shown in FIG. 1, the function key row 111, the number key row 112, the first letter key row 113, the aligning key row 114, the second letter key row 115 and control key row 116. The naming of these key rows has no specific meaning and does not intend to mean all the keys in a row are of the same type. For example, “number key row” does not mean all the keys in the row are number keys, it could also include other key types, e.g. symbols such as mathematical operators. The lengths of different rows are not necessarily the same; on the contrary, a row may comprise only one key, or may have branches or cross with another row. For example, the second letter key row 115 and the aligning key row 114 are relatively short, and the left end of the aligning key row 114 branches a row comprised of “Shift” key and “z” key, and the right end branches a row comprised of “?” key, which in turn merges with the second letter key row 115 into a row comprised of “Shift” key and “Back” key.

The width of a key row refers to the distance between the middle lines respectively of the spaces between the key row and its two adjacent key rows.

The concepts of key column and the width thereof are similar to above. In addition, the direction of any row is the transversal direction, and the direction of any column is the longitudinal direction.

Aligning keys refer to the keys on which the fingers rest when the user is about to operate the keyboard or pauses operation, for example, the keys of “a”, “s”, “d”, “f”, “j”, “k”, “l” and “;” in a conventional QWERTY keyboard.

As shown in FIG. 1, a keyboard of a first embodiment of the invention comprises a plurality of keys such as letter keys and numbers and etc., and a keyboard body 11 supporting the keys. As discussed in the Background Art of the present description, the keyboard may have a QWERTY layout or an AZERTY layout, or even any other layout, such as a layout in which the letter keys are arranged in alphabetic sequence. For sake of clarity and conciseness, only the common QWERTY layout is taken as an example for describing the invention.

In the present embodiment, the widths of the key rows other than the aligning key row 114 are reduced to, for example, 2-9 mm. Thus, on one hand, the size of the keyboard is reduced; on the other hand, when operating the keyboard, the user need not move the wrists and it is sufficient to extend or bend the fingers for the user to touch all the keys. Considering that the fingers rest on the keyboard when pausing operation, the aligning key row is designed so that its width coincides with the physiological features of the fingers, e.g., ranges from 9 to 22 mm.

The width of the key column may be improved similarly. For example, in the embodiment shown in FIG. 1, the widths of the left-most key column, the two right-most key columns and the columns that the two keys between the left and right aligning keys (that is, the keys of “g” and “h” in a QWERTY keyboard) belong to are reduced, e.g., to 3-9 mm. In the mean time, the width of the columns that the aligning keys belong to remain normal size, e.g., of 5-22 mm.

Further, it is known that the fingers are different from each other. Therefore, on each of the left side and right side, the widths of the four columns that the four aligning keys belong to need not be consistent with each other. The widths of the aligning key columns corresponding to the little fingers may be reduced properly, e.g., to 4-14 mm. Similarly, the row widths at the aligning keys corresponding to the little fingers may also be reduced, e.g., to 5-14 mm. After being reduced in size, the upper sides (the off sides, or the sides far from the user and near to the display) of the aligning keys corresponding to the litter fingers are made to be in alignment with the upper sides of the other aligning keys, so that the distribution of all the aligning keys presents a “V” form, which meets better the ergonomic requirements.

In the column direction (longitudinal direction), the distribution of the free heights of the keys may present a form of a wave. By virtue of the variation of the heights, on one hand, the surface of the key board is increased and the problem caused by the high density of the keys is alleviated; on the other hand, locating the keys by the fingers is facilitated.

The keyboard thus modified is small in size and easy to use. However, because of the high density of keys, the keys intend to be mis-switched on. FIG. 10 illustrates the cases where the keys are apt to be mis-switched on due to the high density of keys when the adjacent keys are pressed. In the figure, the shadow areas indicate the travel lengths of the keys defined respectively by the free heights and the on-heights. For preventing the case of mis-switching on, separating ribs may be arranged between key rows and/or key columns. Along any key column, the free height of any key in the valley of the wave is smaller than the height of any of its adjacent separating ribs; the on-height of any key on the peak of the wave is larger than the height of any of its adjacent separating ribs; for the other keys of different heights and the other separating ribs of different heights, the height of any separating rib is smaller than the on-height of the higher of the two adjacent keys and larger than the on-height of the lower of said two adjacent keys, and is preferable selected within the range of from the free height of the lower adjacent key plus one half of the travel length of that key to said free height minus one half of said travel length.

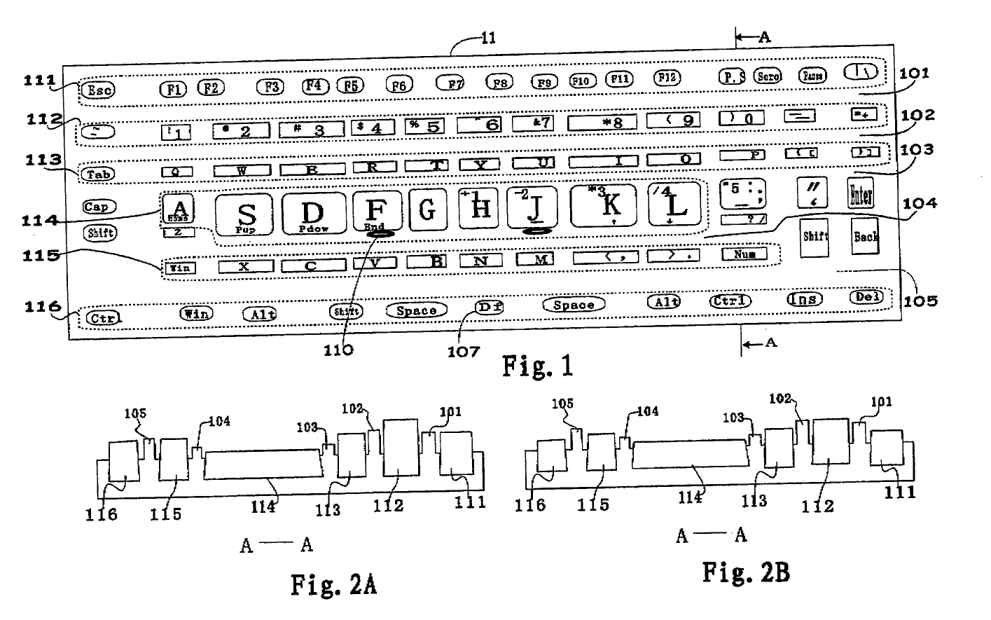

It should be noted that, for sake of clarity and concision of the drawing, FIG. 1 is not drawn pro rata. Particularly, the spaces between the keys are magnified, and the scales in the transversal direction (the direction of key row) and the longitudinal direction (the direction of key column) are not consistent with each other, i.e., the keyboard is stretched in the longitudinal direction. Also, FIG. 1 does not show the separating ribs but only indicates the positions thereof. The separating ribs, i.e., first rib to five rib 101-105, are shown in FIGS. 2A and 2B.

FIG. 11 illustrates the principle of preventing, by virtue of the separating ribs, the keys from being mis-switched on by the fingers.

The separating ribs may be separate elements, or may be formed integral with the keyboard body, as shown in FIGS. 2A and 2B. The widths of the separating ribs vary with their positions and range from 0.2 to 6 mm.

For further reducing the size of the keyboard, the keypad, including number keys and/or cursor keys, of the conventional keyboard may be eliminated and re-defined in the main region (a region including at least the letter keys, corresponding to the left-bottom region of a conventional keyboard) of the keyboard. In the present embodiment, taking a QWERTY keyboard as example, the keyboard may be defined so that the following fives keys, “h”, “j”, “k”, “l” and “;”, may be switched by the Num lock key into number keys “1”, “2”, “3”, “4” and “5”, which, together with the number keys “6”, “7”, “8”, “9” and “0” in the main region of the keyboard, constitute a number keypad. In this state, the upper case of the number keys may be defined as mathematical operators. In addition, a control key, such as “Dr” key 107, may be provided. When the control key 107 is pressed, the keys “a”, “s”, “d” and “f” are switched respectively into Home key, PageUp key, PageDown key and End key; and the keys “j”, “k”, “l” and “;” are switched respectively into leftward, upward, downward and rightward cursor keys. Alternatively, since the longitudinal size of the keyboard is reduced, aforementioned eight cursor keys and/or function control keys such as F1 and so on may be moved to the region below the main region of the keyboard, that is, to the region nearer to the user (in other words, the region on the nearside of the main region).

In the embodiment, due to the reduced widths of the key columns, the two hands will be closer and the user will feel uncomfortable when operating the keyboard. Therefore, in a second embodiment of the invention, the left hand keys region and the right hand keys region are separated by a distance, so that the distance between two hands is increased. Some or all the function keys, Such Enter key, ESC key, Tab key, Cap key and etc,, may be arranged within the central space formed by separating said left hand keys region and right hand keys region away.

To meet the user's habit and psychology, reduce the labor of the fingers and prevent the aligning keys from being mis-switched on, the keys of the keyboard may be designed as having different pressure thresholds. That is, the pressure threshold of the aligning keys and the space key (i e., those keys having larger sizes) is larger than that of most of or all the keys having smaller row and/or column spaces (i.e., the smaller-size keys other than the aligning keys).

To meet the user's habit of locating the keys by fingers, small protrusions or depressions 110 are provided on the ribs corresponding to the central portions of the first knuckles of the fingers operating certain keys, such as of the index fingers.

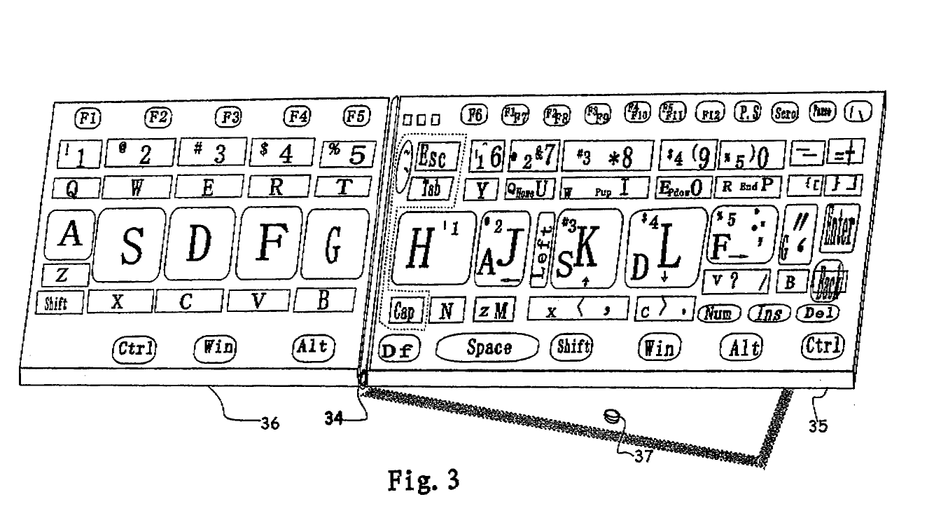

To be more portable, the keyboard may be designed so as to be foldable. For example, as shown in FIG. 3, the keyboard may be formed into two sub-keyboards 35, 36 that are articulated by hinge 34 between the left hand keys region and the right hand keys region. In FIG. 3, the function keys moved into the central space as described above may be arranged on the right sub-keyboard corresponding to the right hand keys region; alternatively, they may be arranged on the left sub-keyboard corresponding to the left hand keys region.

In a variant of the embodiment, a detector 37 is provided in the keyboard for sensing whether the keyboard is in folded state or open state. In the folded state, the detector 37 sets the keyboard into a mono-hand mode. For example, as shown in FIG. 3, the right sub-keyboard corresponding to the right hand keys region may be set as a mono-hand keyboard. Certainly, it may be the left sub-keyboard corresponding the left hand keys region to be set as a mono-hand keyboard. Here, the detector realizing above functions may be implemented by prior arts and the detailed description thereof is omitted.

A change-over key may be provided for switching the mono-hand keyboard set as above between a left hand mode and a right hand mode. For example, as shown in FIG. 3, a change-over key “left” may be provided within a separating rib between aligning keys, such as the aligning keys corresponding to the index finger and the middle finger. Such arrangement will facilitate key stroking and occupy less space. In a default mode, the sub-keyboard is a right hand keyboard. When the “left” key is pressed, the keyboard will switch into a mode of left hand keyboard. Taking a QWERTY keyboard layout as example, when the “left” key is pressed, the keys of “j”, “k” and “l” switch into keys of “a”, “s” and “d” respectively, and the other keys switch similarly. When the “left” key is pressed once again, or after a predetermined period has lapsed, the sub-keyboard restores its right hand mode. Where the left sub-keyboard corresponding to the left hand keys region functions as a mono-hand keyboard, a similar change-over key may be provided for switching the sub-keyboard from a default left hand mode into a right hand mode.

Said change-over key, such as the “left” key arranged within the separating rib between the aligning keys corresponding to the middle finger and the index finger, is of a longitudinal elongated form, is not lower than its peripheral ribs and is higher than the adjacent aligning keys.

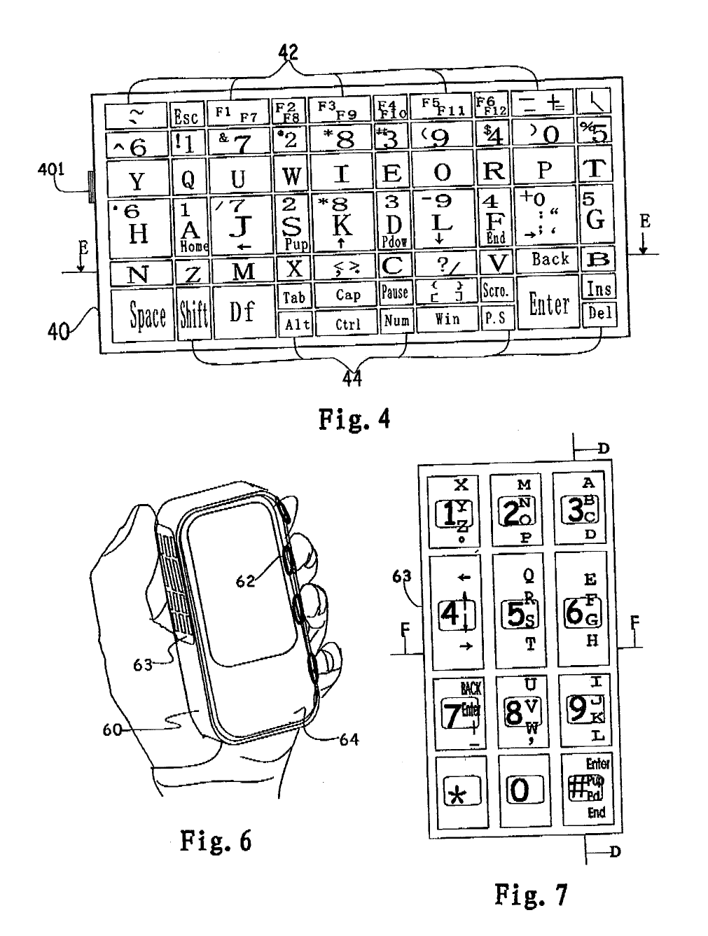

A fourth embodiment of the invention is shown in FIG. 4. The embodiment is a mono-hand keyboard 40 suitable for mobile phone and PDA and etc. The present embodiment is similar to the first embodiment in terms of the distribution of the widths of the key rows and other optional features in the direction of key column, such as the arrangement and heights of the separating ribs between the key rows, the distribution of the heights of the key rows and corresponding settings of the heights of the separating ribs. The difference is, depending on applications, the width of the aligning key row may range from 5 to 17 mm, and the number of key rows and the number of key columns may be more or less, The most important is that the features along the direction of key row(transversal direction) and the key code layout are different.

In particular, wider key columns and narrower key columns are arranged alternating. The width of the wider key columns may range from 5-17 mm, and the width of the narrower key columns may range from 3-9 mm. As shown in FIG. 4, all the wider key columns as a whole function as a right hand keys region 42, and all the narrower key columns as a whole function as a left hand keys region 44. Certainly, the left hand keys region may correspond to the wider key columns and the right hand keys region may correspond to the narrower key columns. When operating the keyboard as shown in FIG. 4 by the right hand, for moving between the left hand keys region and the right hand keys region, it is sufficient for the user to move the hand by a distance of one key. Therefore, compared to the conventional PDA keyboard that generally has the keys arranged in an alphabetical sequence, the present embodiment provides a layout that is similar to the PC keyboard so that the user may follow the conventional operating manner and may operate the keyboard in a higher speed. Furthermore, the keyboard need not be operated by both hands and, when operating the keyboard by single hand, the user need not move the hand by a too great distance.

Similarly, for preventing the keys from being mis-switched on, separating ribs similar to those of the first embodiment may be arranged between the key columns. The detailed description is omitted.

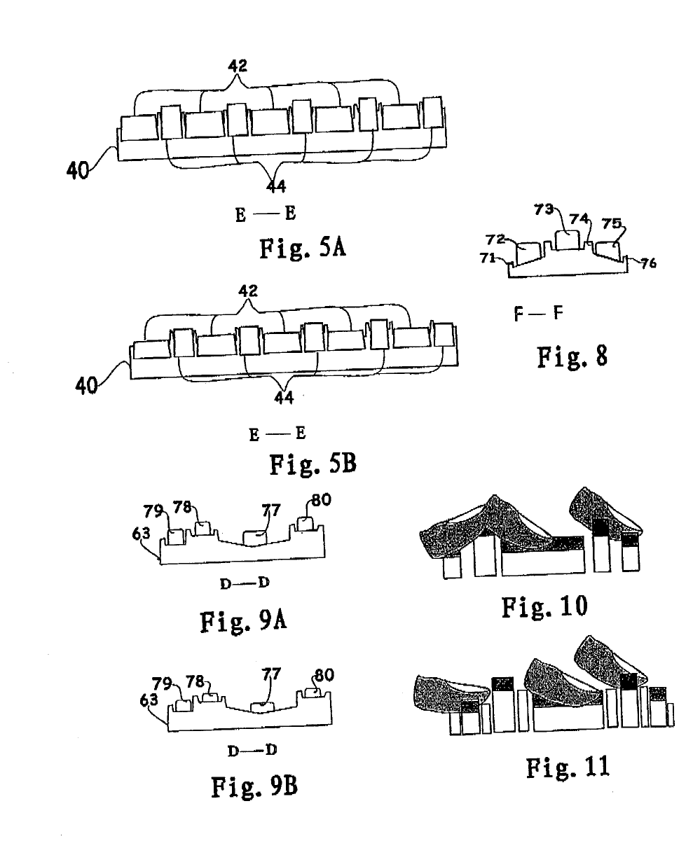

Additionally, the narrower key columns may be higher than the wider key columns, as shown in FIG. 5A and 5B. In this case, the on-height of any key in the higher key column is higher than the column separating ribs on its both sides, and the free height of any key in the lower key column is lower than the column separating ribs on its both sides.

If the keyboard of the present embodiment is applied in a mobile information apparatus such as mobile phone, PDA and etc., the default key code layout may be set as number key layout, which is switched into a layout similar to the letter key layout of PC only when a function key such as a key 401 provided on the side of the keyboard is pressed.

Similar to the first embodiment, in the character layout of the keyboard of the present embodiment, some letter keys may be switched into number keys and cursor control keys. For example, as shown in FIG. 4, the keys of “a”, “s”, “d”, “f”, “g”, “h”, “j”, “k”, “l” and “;”, may be switched by the Num lock key into number keys “1”, “2”, “3”, “4”, “5”, “6”, “7”, “8”, “9” and “0”. Also for example, as shown in FIG. 4, a control key “Df” similar to that in FIG. 1 may be arranged to, when pressed, switch the keys “a”, “s”, “d” and “f'8 respectively into Home key, PageUp key, PageDown key and End key, and switch the keys “j“, “k”, “l” and “;” respectively into leftward, upward, downward and rightward cursor keys.

A keyboard according to a fourth embodiment of the invention is shown in FIG. 7, and a mobile information apparatus, such as a mobile phone, comprising the keyboard is shown in FIG. 6.

First a description will be given to the keyboard. The keyboard 63 is similar to the keyboard in the first embodiment in terms of its physical structure. The difference is that, considering its application (such as in mobile phone), the main region of the keyboard comprises at least 12 keys of the conventional phone keyboard. The keys are arranged in 4 rows multiply 3 columns, with the width of the aligning key row 77 (on which the thumb rests) greater than the widths of the key columns. Thus, the whole keyboard is in an elongated form facilitating its arrangement on a side surface 60 of a mobile information apparatus such as mobile phone.

The width of the aligning key row 77 may range from 4 to 16 mm, and is greater than the widths of the other key rows, 3-9 mm. The widths of the key columns may range from 3 to 9 mm.

Similar to the first embodiment, separating ribs, of widths of 0.2-7 mm, may be arranged between key rows and/or between key columns. And, as shown in FIGS. 9A and 9B, a first key row 80 and a third key row, both adjacent to the aligning key row 77, may be higher than said aligning key row 77 and a fourth key row 79. The on-height of any key in the higher first key row 80 and third key row 78 is higher than their adjacent separating ribs (row separating ribs), and the free height of any key in the lower aligning key row 77 and fourth key row 79 is lower than their adjacent separating ribs(row separating ribs).

If the present keyboard is to be incorporated on the side surface of a mobile information apparatus, then, as shown in FIG. 8, the intermediate key column 78 may be higher than a first key column 72 and a second key column on its both sides- In this case, the on-height of any key in the intermediate key column 73 on the peak should be higher than its adjacent separating ribs (column separating ribs) 74, the on-height of any key in the two side key columns should be higher than, respectively, the outermost first separating rib 71 and the outermost second separating rib (column separating ribs) 76, but lower than the separating ribs (column separating ribs) between the side key columns and the intermediate key column.

Key code indications may be printed on the keys and/or the key panel and/or separating ribs around respective keys.

The keyboard 63 according to the fourth embodiment of the invention may be applied in a mobile information apparatus such as a mobile phone, as shown in FIG. 6. In this case, since the keyboard is in an elongated form, it can be arranged on a side surface, such a first side 60, of the mobile information apparatus. Thus, when the apparatus is grasped in hand naturally, the keyboard may be naturally operated by the thumb. In this case, said aligning key refers to the aligning key for the thumb, and said aligning key row refers to the row that said aligning key belongs to.

On a second side of the apparatus and opposite to the first side 60, may be arranged a plurality of function keys 62, such as four function keys, to be operated by the other four fingers of the grasping hand. These function keys and the keyboard may be used independently or in combination. Whey they are used in combination, different sets of key codes will be generated. For example, in a normal mode, the keyboard may function as a number keyboard. When combined with a first function key, the keyboard corresponds to a first set of characters; when combined with a second function key, the keyboard corresponds to a second set of characters; and so on. Said characters may be letters, strokes or control characters such as “Back”, “Enter”, or the like.

In aforementioned embodiments, further modifications are possible. For example, since both the row width and the column width are reduced, the key code indications, which are printed on the top surfaces of the keys in a conventional keyboard, may be extended onto the separating ribs and/or key panel around respective keys. As another example, the keyboard of the fourth embodiment may be arranged on the front face 64 of a mobile information apparatus and the function keys may be arranged on any other side facilitating the key-stroking of the other four fingers.

Although the invention has been described with reference to specific embodiments, the invention is not limited to these embodiments, which may be varied or modified without departure from the spirit and the scope of the invention.

For example, as mentioned above, the specific layouts disclosed in the description are only exemplary. For a person skilled in the art, the key code layouts may be changed or modified without affecting the objects and/or functions of the invention. For example, the change-over key and/or function keys may be moved to any positions; and some unnecessary keys may be added into or omitted from the keyboards, e.g., some keys may be added into the keyboards as shown in FIG. 4 or 7. Moreover, in the description of the invention, QWERTY keyboards and number keypads are taken as examples. For a person skilled in the art, it is very easy to apply the invention to any other keyboard layout, such as AZERTY keyboard layout. Furthermore, as mentioned above, given a keyboard layout, the implementation of the specific circuits belongs to conventional techniques for a person skilled in the art, and thus is unnecessary to be discussed here; besides, the implementation of the specific circuits does not belong to the scope of the present invention.

1. A keyboard comprising: a plurality of keys, including aligning keys on which the fingers rest when the user is about to operate the keyboard or during any pause in operation; and a keyboard body supporting said keys, characterized in that, the width of the row that the aligning keys belong to is greater than the width of any other key row.

2. A keyboard according to claim 1, characterized in that, along each key column, the distribution of the heights of the keys is in a form of a wave, and separating ribs are provided at least between the key rows, the free height of the key in the valley of the wave is smaller than the height of either of its adjacent separating ribs, the on-height of the key on the peak of the wave is larger than the height of either of its adjacent separating ribs, and, for the other keys of different heights and the other separating ribs of different heights, the height of any separating rib is smaller than the on-height of the higher of its two adjacent keys and larger than the on-height of the lower of said two adjacent keys.

3. A keyboard according to claim 2, characterized in that, for said other keys of different heights and said other separating ribs of different heights, the height of any separating rib is selected within the range of from the free height of the lower of said two adjacent keys plus one half of the travel length of said key to that free height minus one half of said travel length.

4. A keyboard according to any of claims 1-3, characterized in that, the widths of the aligning key columns corresponding to the ring fingers and the little fingers are smaller than the widths of the aligning key columns corresponding to the index fingers and the middle fingers, the row widths at the aligning keys corresponding to the little fingers are reduced, and the upper sides of all the aligning keys are in alignment.

5. A keyboard according to any of claims 1-3, characterized in that the key code indications are printed on the top surfaces of the keys and/or the key panel and/or separating ribs around respective keys, and/or extended onto the top surface(s) of adjacent larger key(s).

6. A keyboard according to any of claims 1-3, characterized in that, the pressure thresholds of said aligning keys and the space key are larger than those of some or all the other keys.

7. A keyboard according to any of claims 1-3, characterized in that, the keyboard is formed by articulating a left keyboard portion and a right keyboard portion so as to be foldable.

8. A keyboard according to claim 7, characterized in that a detector is provided in the keyboard for setting said left keyboard portion or said right keyboard portion into a mono-hand mode when the keyboard is folded, and that a change-over key is provided in the keyboard for switching the keyboard in said mono-hand mode between a left hand mode and a right hand mode.

9. A keyboard according to any of claims 1-3, characterized in that the keyboard is provided with at least one change-over keys for switching the keyboard between at least two key code layouts, and/or switching some keys in the main region into number keypad and cursor control keys, and/or re-defining the shift codes of the number keys as mathematical operators.

10. A keyboard according to claim 9, characterized in that said at least one change-over key is arranged within at least one separating rib between the aligning keys, and the on-height thereof is not lower than said separating rib.

11. A keyboard according any of claims 1-3, characterized in that, the circuit board thereof is completed by arranging a keyboard processor circuit board of a prior art membrane keyboard beneath a printed circuit board merely comprising a switch matrix and in a region corresponding to the central portion of said printed circuit board, and connecting the corresponding leads of the two circuit boards by means of connecting devices.

12. A keyboard according to any of claims 1-3, characterized in that, the cursor control keys and/or function control keys are arranged below the main region of the keyboard, and an Enter key and/or a Shift key is arranged near the Space key.

13. A keyboard according to any of claims 1-3, characterized in that, key columns of two widths are arranged alternating, and the key columns of each width, as a whole, are defined as a left hand keys region or a right hand keys region.

14. A keyboard according to claim 13, characterized in that, the keys in the narrower key columns are higher than the keys in the wider key columns, column separating ribs are provided between the key columns, and the on-height of any key in the higher key columns is higher than the column separating ribs on its both sides, and the free height of any key in the lower key columns is lower than the column separating ribs on its both sides.

15. A keyboard according to claim 14, characterized in that the key code indications are printed on the top surface of the keys and/or the key panel and/or separating ribs around respective keys, and/or extended onto the top surface(s) of adjacent larger key(s).

16. A keyboard according to claim 14, characterized in that the keyboard is provided with at least one change-over keys for switching the keyboard between at least two key code layouts, and/or switching some keys in the main region into number keypad and cursor control keys, and/or re-defining the shift codes of the number keys as mathematical operators.

17. A keyboard according to claim 1, characterized in that the width of the aligning key row is greater than the widths of the key columns.

18. A keyboard according to claim 17, characterized in that the keyboard comprises at least four key rows multiply three key columns, and row separating ribs and column separating ribs are provided respectively between the key rows and between the key columns, wherein, the two key rows adjacent to the aligning key row are higher than said aligning key row and the other key row, the on-height of any key in the higher key rows is higher than its two adjacent row separating ribs, and the free height of any key in the lower key rows are lower than its two adjacent row separating ribs; the intermediate key column is higher than the two side key columns on its two sides, the on-height of any key in the intermediate key column is higher than its adjacent column separating ribs, the on-height of any key in the two side key columns is higher than the outermost column separating ribs but lower than the column separating ribs between the side key columns and the intermediate key column.

19. A portable information apparatus, comprising a keyboard arranged on a first side surface of the apparatus and to be operated by the thumb of the hand grasping the apparatus, and a plurality of function keys arranged on a second side surface of the apparatus and to be operated by the other four fingers of the grasping hand, wherein the keyboard is a keyboard according to claim 17 or 18.

20. A portable information apparatus according to claim 19, characterized in that the keyboard and the function keys are to be operated either independently or in combination, when operated in combination, the keyboard and the function keys are defined so that each combination of the keyboard with one of the plurality of function keys corresponds to a different set of key codes of the keyboard.
